(19) United States
(12) Patent Application Publication
(10) Pub. No.: US 2016/0178930 A1
(43) Pub. Date: Jun. 23, 2016

(54) Adjustable Hinge Arrangement For Eyewear

(71) Applicants: Aaron Stuart Drew, Fairfax, VA (US); Daniel Kang, Fairfax, VA (US); Isaac Kim, Fairfax, VA (US)

(72) Inventors: Aaron Stuart Drew, Fairfax, VA (US); Daniel Kang, Fairfax, VA (US); Isaac Kim, Fairfax, VA (US)

(21) Appl. No.: 14/578,673

(22) Filed: Dec. 22, 2014

(51) Int. Cl. G02C 5/22

(52) U.S. Cl. CPC G02C 5/2281; G02C 2200/08

(57) ABSTRACT

Systems and methods may provide an adjustable eyewear piece, and may include implementing an adjustable hinge mechanism to detachably couple a first eyewear component and a second an eyewear component. In one example, the adjustable eyewear component may include a frame, a temple arm, and an adjustable hinge mechanism to couple the frame and the temple arm.

The present application claims the benefit of U.S. provisional patent application Ser. No. 61/920,752 filed on Dec. 25, 2013. The disclosure of the co-pending provisional application is incorporated herein by reference in its entirety.

### BACKGROUND

1. Technical Field

Embodiments generally relate to adjustable eyewear. More particularly, embodiments relate to implementing an adjustable hinge mechanism to detachably couple components of an eyewear piece.

2. Discussion

Typically, an eyewear piece includes a temple arm that is securely attached to a frame. In such cases, the temple arm may typically only be removed using physical force that involves bending the proper attachment arrangement of the temple arm and the frame beyond a normal orientation.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is an illustration of an example of an eyewear piece including an adjustable hinge arrangement according to an embodiment;

FIG. 2 is an illustration of an example of an exploded view of an adjustable hinge arrangement according to an embodiment;

FIG. 3 is an illustration of an example of a cross-section view of an adjustable hinge arrangement according to an embodiment;

FIGS. 4A-C are an illustration of an example of utilizing an adjustable hinge arrangement according to an embodiment;

FIGS. 5A-C are an illustration of an example of utilizing an adjustable hinge arrangement according to an embodiment;

FIG. 6 is a flowchart of an example of a method of coupling a first component and a second component of an eyewear piece utilizing an adjustable hinge arrangement according to an embodiment; and

FIG. 7 is a flowchart of an example of a method of detaching a first component and a second component of an eyewear piece utilizing an adjustable hinge arrangement according to an embodiment.

### DETAILED DESCRIPTION

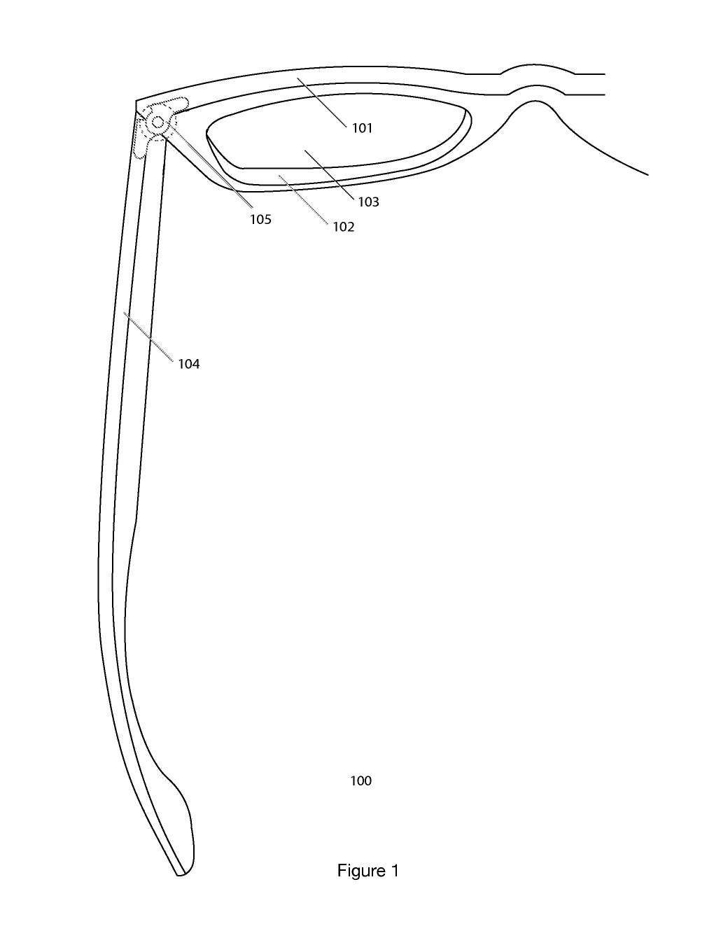

FIG. 1 is an illustration of an example of an eyewear piece including an adjustable hinge arrangement according to an embodiment. Eyewear piece 100 may be any item of apparel that may be configured to utilize adjustable hinge arrangement 105. In this example, the eyewear piece 100 may be a pair of reading glasses. The eyewear piece 100 may include a frame 101, a rim 102, a lens 103, a temple arm 104, and the adjustable hinge arrangement 105.

The frame 101 may hold the lens 103 in place, and may serve as a support bridge above the user's nose. The rim 102 may be coupled to the frame 101, and may be configured to receive the lens 103 upon insertion. The temple arm 104 may run length-wise along the side of a user's face, and may extend over and/or behind the user's ears to hold the eyewear piece 100 in place.

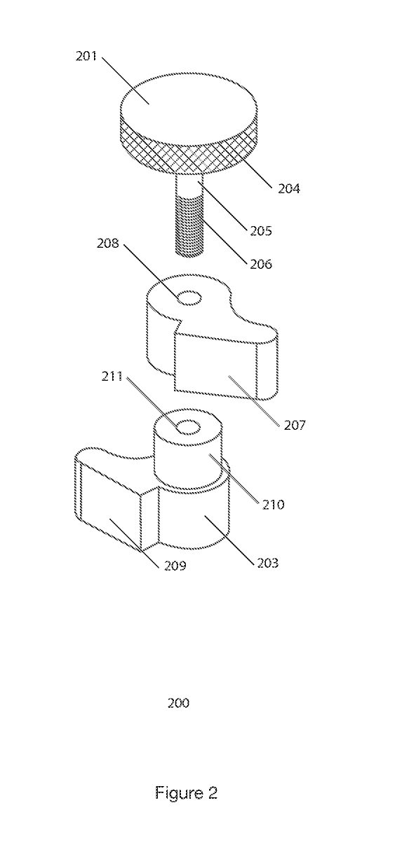

FIG. 2 is an illustration of an example of an exploded view of an adjustable hinge arrangement according to an embodiment. In this example, adjustable hinge arrangement 200 may include a screw 201, a first hinge component 202, and a second hinge component 203.

The screw 201 may include a screw head 204, a screw shank 205, and a screw thread 206. The screw head 204 may be located on a first end of the screw 201. The screw shank 205 may couple the screw head 204 and the screw thread 206. The screw thread 206 may be a continuous helical groove etched on the screw 201.

The first hinge component 202 may include a first leaf portion 207, a first screw hole 208, and a female cavity component. The first leaf portion 207 may enable the first hinge component 202 to be coupled to another component (e.g., a rim, a temple arm) of an eyewear piece. The first screw hole 208 may be configured to receive the screw 201, in order to couple the first hinge component 202 to another component (e.g., the second hinge component 203).

The second hinge component 203 may include a second leaf portion 209, a male extension component 210, and a second screw hole 211. The second leaf portion 209 may enable the second hinge component 203 to be coupled to another component (e.g., a frame, a temple arm) of an eyewear piece. The male extension component 210 may be configured to allow its insertion into the female cavity component of the first hinge component 202 in order to couple the first hinge component 202 and the second hinge component 203. The second screw hole 211 may be configured to receive the screw 201 in order to couple the second hinge component 203 to another component (e.g., the first hinge component 202).

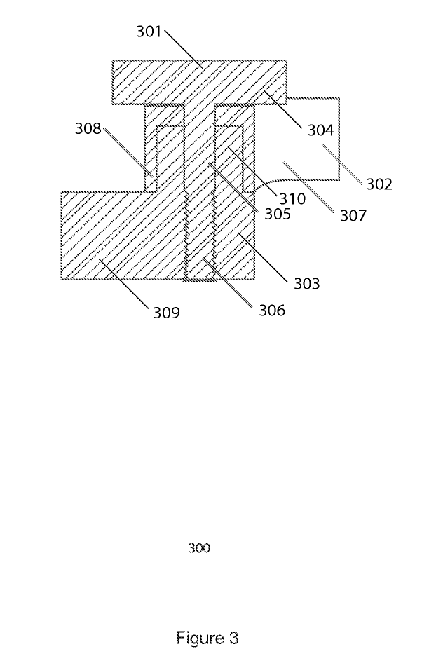

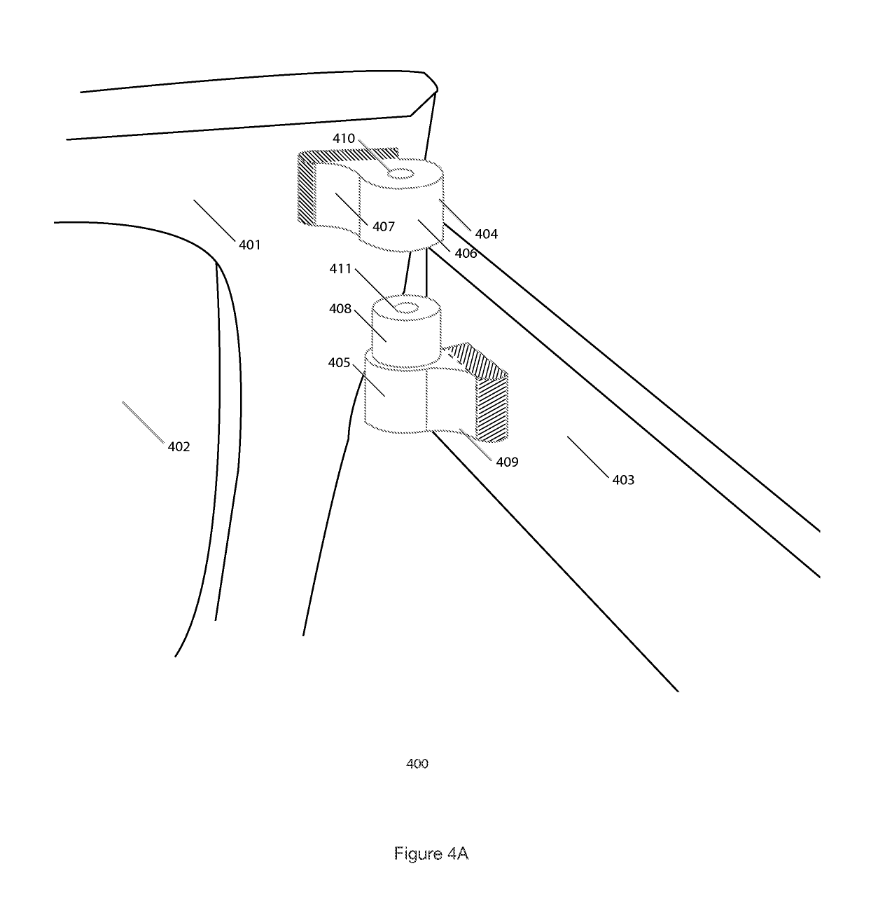

FIG. 3 is an illustration of an example of a cross-section view of an adjustable hinge arrangement according to an embodiment. In this example, FIG. 3 illustrates adjustable hinge arrangement 300 (similar to the adjustable hinge arrangement 200, FIG. 2). The adjustable hinge arrangement 300 may include a screw 301, a first hinge component 302, and a second hinge component 303.

In this embodiment, the screw 301 may include a screw head 304, a screw shank 305, and a screw thread 306. The screw head 304 may be used to insert the screw shank 305 and a screw thread 306 into a first screw hole (similar to the first screw hole 208, FIG. 2) in the first hinge component 302 and a second screw hole (similar to the second screw hole 211, FIG. 2) in the second hinge component 303.

The first hinge component 302 may include a first leaf portion 307 and a female cavity component 308. The first leaf portion 307 may be configured to couple the first hinge component 302 to another component of an eyewear piece (e.g., a frame, a temple arm). The female cavity component 308 may be a structure configured to allow an empty space in which another structure may be inserted.

The second hinge component 303 may include a second leaf portion 309 and a male extension component 310. The second leaf portion 309 may be configured to couple the second hinge component 303 to another component of an eyewear piece (e.g., a frame, a temple arm). The male extension component 310 may configured to include a structural extension that may be inserted into the female cavity component 308 in order to couple the first hinge component 302 and the second hinge component 303.

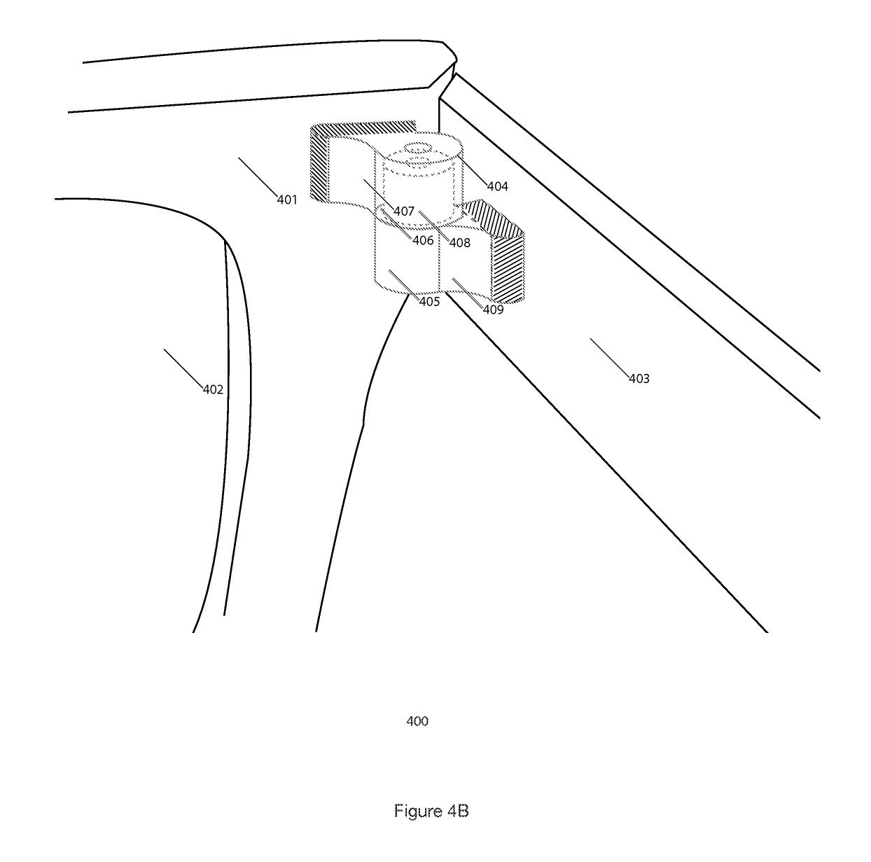

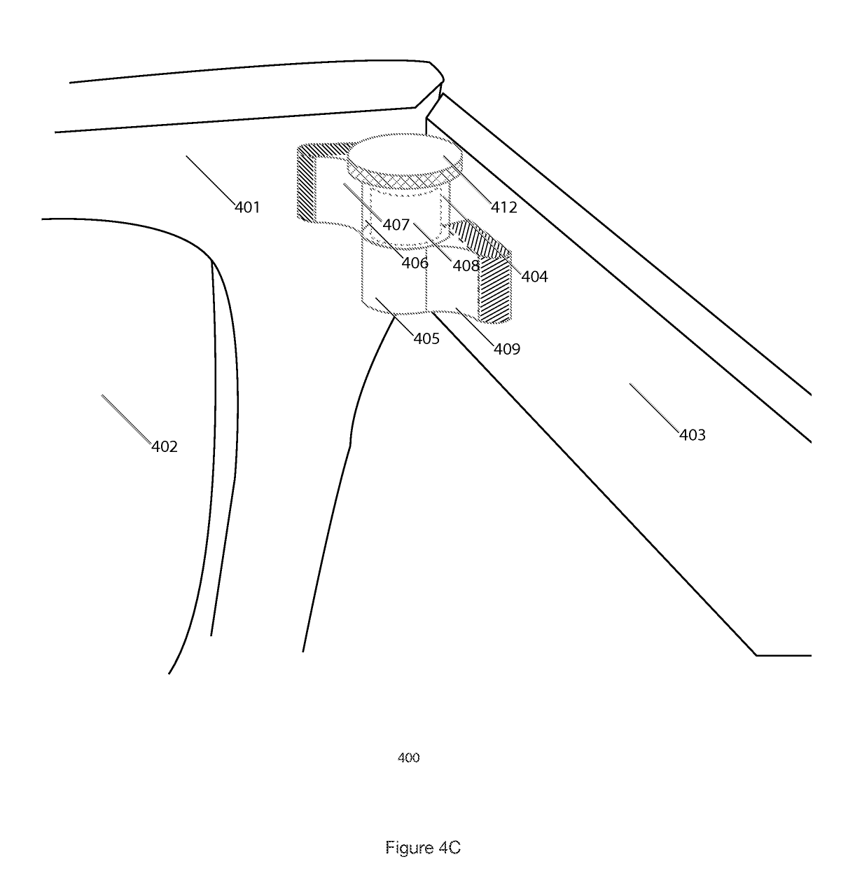

FIGS. 4A-C are an illustration of an example of a utilization of an adjustable hinge arrangement to couple a first eyewear component and a second eyewear component according to an embodiment. In FIG. 4A, an eyewear piece 400 may include a frame 401, a lens 402, and a temple arm 403. In this example, the frame 401 may be coupled a first hinge component 404, and the temple arm 403 may be coupled to a second hinge component 405.

The first hinge component 404 may include a female cavity component 406, a first leaf portion 407, and a first screw hole 410. The second hinge component 405 may include a male extension component 408, a second leaf portion 409, and a second screw hole 411. The first leaf portion 407 may be used to couple the first hinge component 404 to the frame 401, and the second leaf portion 409 may be used to couple the second hinge component 405 to the temple arm 403.

In FIG. 4B, the male extension component 408 (as indicated by the dotted lines) of the second hinge component 405 may be inserted into the female cavity component 406 of the first hinge component 404 in order to couple the frame 401 and the temple arm 403.

In FIG. 4C, a screw 412 may be utilized to couple the first hinge component 404 and the second hinge component 405, and by extension, couple the frame 401 and the temple arm 403. In particular, in this example, the screw 412 may be inserted into the first screw hole 410 (not shown) of the first hinge component 404 and the second screw hole 411 (not shown) of the second hinge component 405. The screw 412 may then be rotated in a particular direction (e.g., clockwise) until the screw 412 securely couples the first hinge component 404 and the second hinge component 405.

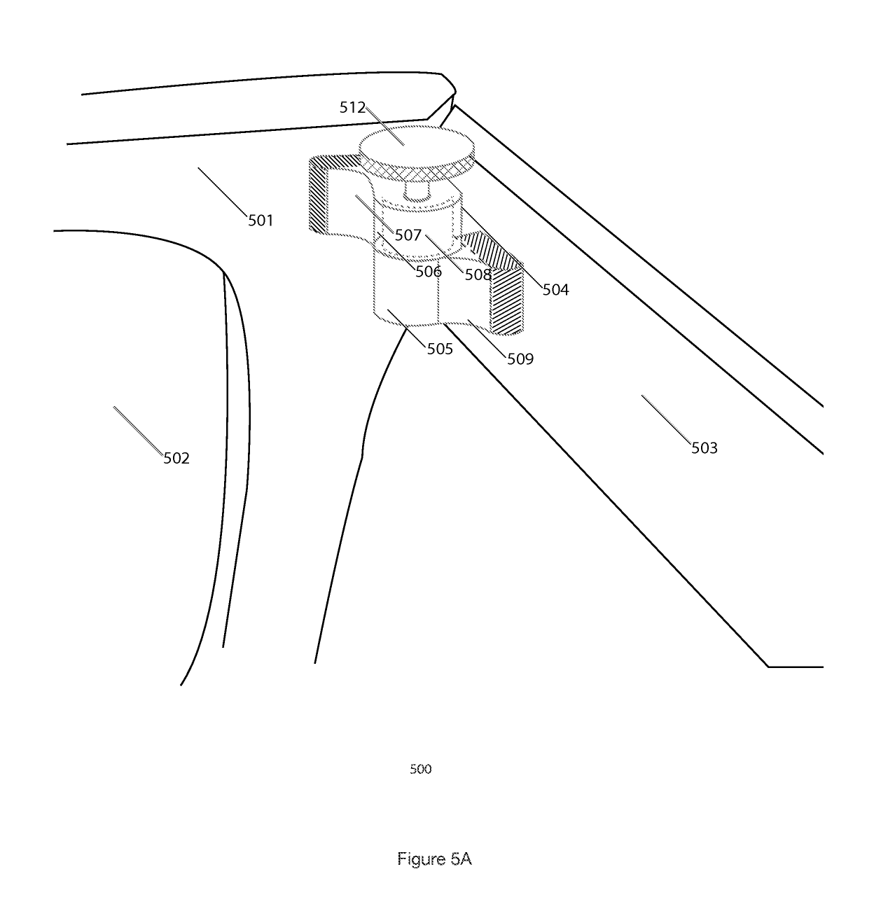

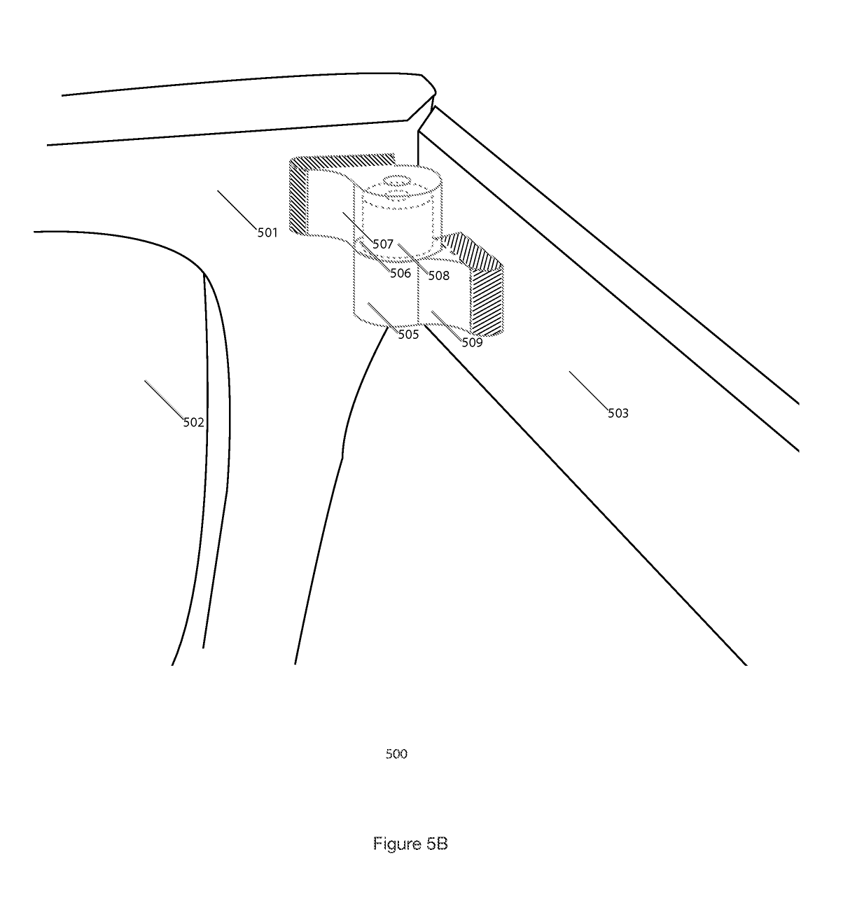

FIGS. 5A-C are an illustration of an example of a utilization of an adjustable hinge arrangement to detach a first eyewear component and a second eyewear component according to an embodiment. The eyewear piece 500 may include a frame 501, a lens 502, and a temple arm 503. In this example, the frame 501 may be coupled a first hinge component 504, and the temple arm 503 may be coupled to a second hinge component 505.

The first hinge component 504 may include a female cavity component 506, a first leaf portion 507, and a first screw hole 510. The second hinge component 505 may include a male extension component 508, a second leaf portion 509, and a second screw hole 511. The first leaf portion 507 may be used to couple the first hinge component 504 to the frame 501, and the second leaf portion 509 may be used to couple the second hinge component 505 to the temple arm 503.

In FIG. 5A, a screw 512 may be utilized to uncouple the first hinge component 504 and the second hinge component 505, and by extension, uncouple the frame 501 and the temple arm 503. Specifically, the screw 512 may be un-screwed from the first hinge component 504 and the second hinge component 505 by rotating in a particular direction (e.g., counter-clockwise) until the screw 512 is released.

In FIG. 5B, upon removal of the screw 512, a male extension component 508 (as indicated by the dotted lines) of the second hinge component 505 may be seen as having been (previously) inserted into the female cavity component 506 of the first hinge component 504.

In FIG. 5C, the male extension component 508 of the second hinge component 505 may be extracted from the female cavity component 506 of the first hinge component 504, thereby uncoupling the frame 501 and the temple arm 503.

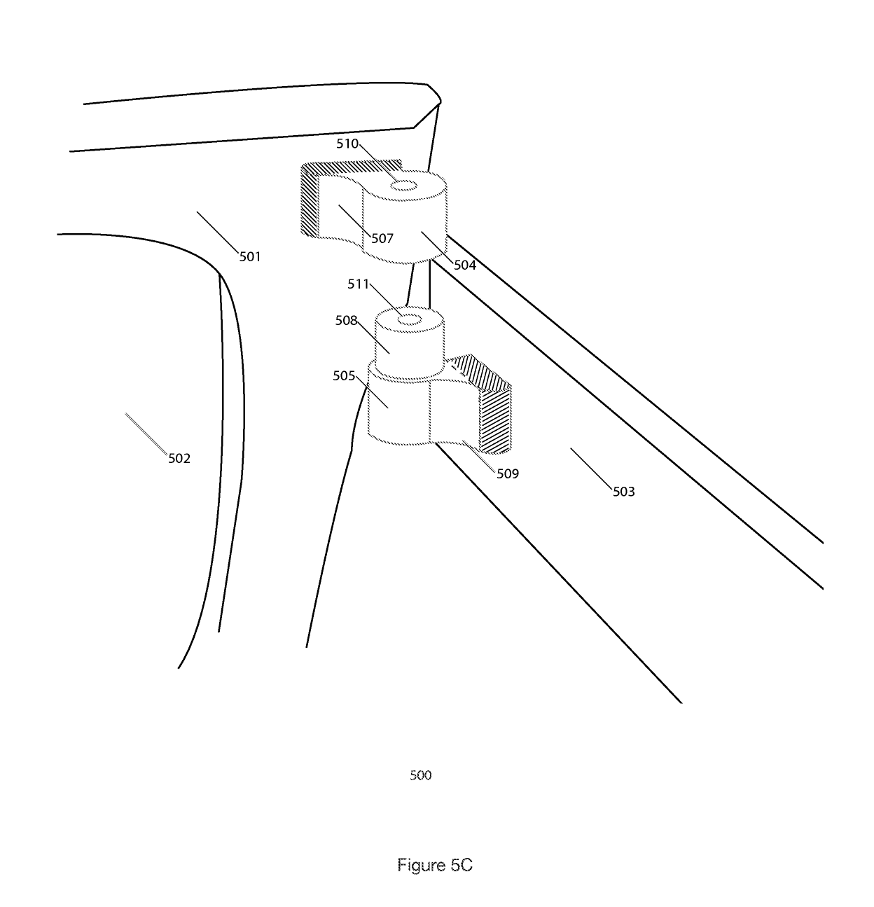

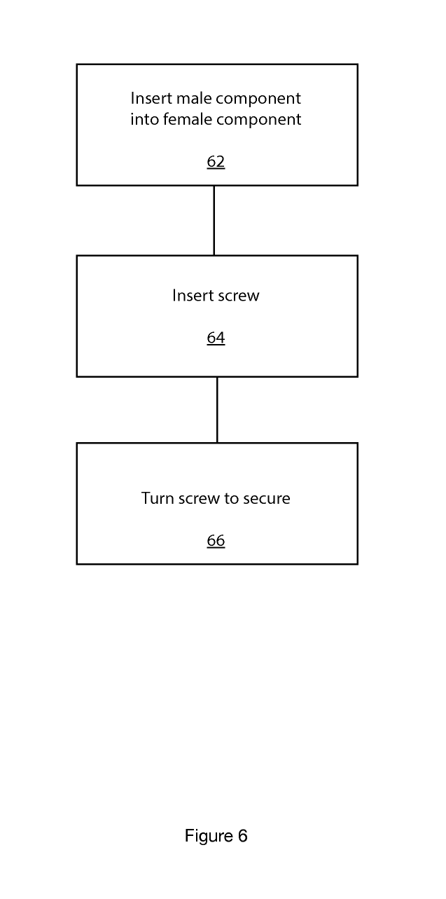

FIG. 6 is a flowchart of an example of a method of coupling a first component and a second component of an eyewear piece utilizing an adjustable hinge arrangement according to an embodiment. In this example, an eyewear piece (similar to the eyewear piece 400, FIG. 4A) may include a frame (similar to the frame 401, FIG. 4A) and a temple arm (similar to the temple arm 403, FIG. 4A), wherein the frame may be coupled to the temple arm utilizing an adjustable hinge arrangement (similar to the adjustable hinge arrangement 200, FIG. 2).

At block 62, a first hinge component (similar to the first hinge component 404, FIG. 4A) coupled to the frame may be coupled to a second hinge component (similar to the second hinge component 405, FIG. 4A) coupled to the temple arm. In particular, a male extension component (similar to the male extension component 408, FIG. 4A) of the second hinge component may be inserted into a female cavity component (similar to the female cavity component 406, FIG. 4A) of the first hinge component.

At processing block 64, a screw (similar to the screw 301, FIG. 3) may be utilized to couple the first hinge component and the second hinge component, and by extension, couple the frame and the temple arm. Specifically, in this example, the screw may be inserted into a first screw hole (similar to the first screw hole 208, FIG. 2) of the first hinge component and a second screw hole (similar to the second screw hole 211, FIG. 2) of the second hinge component.

At processing block 66, the screw may be rotated to tighten (i.e., insert) the screw to couple the first hinge component and the second hinge component together, and thereby coupling the frame and the temple arm together as well.

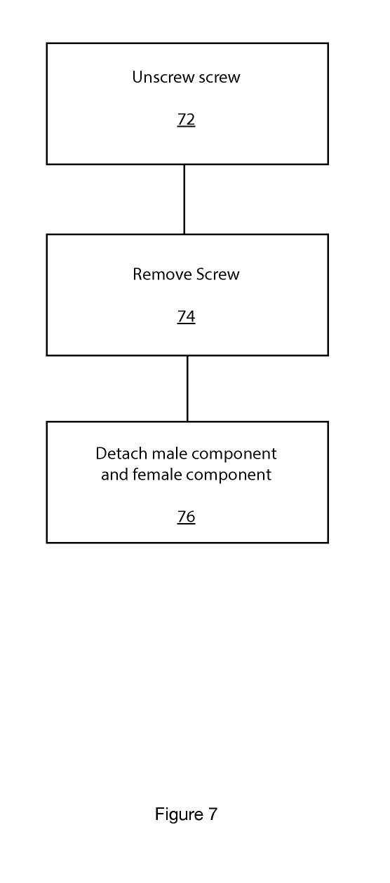

FIG. 7 is a flowchart of an example of a method of detaching a first component and a second component of an eyewear piece utilizing an adjustable hinge arrangement according to an embodiment. In this example, an eyewear piece (similar to the eyewear piece 400, FIG. 4A) may include a frame (similar to the frame 401, FIG. 4A) and a temple arm (similar to the temple arm 403, FIG. 4A), wherein the frame may be detached from the temple arm utilizing an adjustable hinge arrangement (similar to the adjustable hinge arrangement 200, FIG. 2).

At block 72, a first hinge component (similar to the first hinge component 404, FIG. 4A) coupled to the frame may be detached from a second hinge component (similar to the second hinge component 405, FIG. 4A) coupled to the temple arm. In particular, a screw (similar to the screw 301, FIG. 3) may be rotated to loosen (i.e., extract) the screw from the first hinge component from the second hinge component.

At block 74, the screw may be removed from the first hinge component and the second hinge component.

At block 76, a male extension component (similar to the male extension component 408, FIG. 4A) of the second hinge component may be separated from a female cavity component (similar to the female cavity component 406, FIG. 4A) of the first hinge component to uncouple the frame and the temple arm, thereby uncoupling the frame and the temple arm as well.

Embodiments may therefore an apparatus comprising a frame, a temple arm, and an adjustable hinge mechanism to couple the frame and the temple arm.

In one example, the adjustable hinge mechanism includes a screw, a first hinge component, and a second hinge component.

In another example, the first hinge component includes a female cavity component.

In still another example, the second hinge component includes a male extension component.

In one example, the first hinge component includes a first leaf portion to couple the first hinge component to the frame.

In still another example, the second hinge component includes a second leaf portion to couple the second hinge component to the temple arm.

In another example, the male extension component is to be inserted into the female cavity component to detachably couple the first hinge component to the second hinge component.

In one more example, the screw is inserted into a first screw hole in the first hinge component and a second screw hole in the second hinge component to detachably couple the first hinge component to the second hinge component.

In another example, the apparatus may include a rim and a lens.

Still another embodiment may provide an apparatus comprising an adjustable hinge mechanism to couple a frame and a temple arm, wherein the adjustable hinge mechanism includes a screw, a first hinge component, and a second hinge component.

In one more example, the first hinge component includes a female cavity component.

In still another example, the second hinge component includes a male extension component.

Yet another embodiment may provide for a method comprising inserting a male extension component of a first hinge component into a female cavity component of a second hinge component, inserting a screw into a first screw hole of the first hinge component and a second screw hole of the second hinge component, and rotating the screw in a first direction to couple the first hinge component and the second hinge component.

In one example, the method includes rotating the screw in a second direction to uncouple the first hinge component and the second hinge component.

In another example, the method includes removing the screw from the first hinge component and the second hinge component.

In still another example, the method includes detaching the male extension component of the first hinge component from the female cavity component of the second hinge component to uncouple a first eyewear component and a second eyewear component.

In yet another example, the first eyewear component is a frame.

In another example, the second eyewear component is a temple arm.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. An apparatus, comprising:
a frame;
a temple arm; and
an adjustable hinge mechanism to couple the frame and the temple arm.

2. The apparatus of claim 1, wherein the adjustable hinge mechanism includes a screw, a first hinge component, and a second hinge component.

3. The apparatus of claim 2, wherein the first hinge component includes a female cavity component.

4. The apparatus of claim 3, wherein the second hinge component includes a male extension component.

5. The apparatus of claim 4, wherein the first hinge component includes a first leaf portion to couple the first hinge component to the frame.

6. The apparatus of claim 4, wherein the second hinge component includes a second leaf portion to couple the second hinge component to the temple arm.

7. The apparatus of claim 4, wherein the male extension component is to be inserted into the female cavity component to detachably couple the first hinge component to the second hinge component.

8. The apparatus of claim 7, wherein the screw is inserted into a first screw hole in the first hinge component and a second screw hole in the second hinge component to detachably couple the first hinge component to the second hinge component.

9. The apparatus of claim 8, further including a rim and a lens.

10. An apparatus, comprising:
a adjustable hinge mechanism to couple a frame and a temple arm, wherein the adjustable hinge mechanism includes a screw, a first hinge component, and a second hinge component.

11. The apparatus of claim 10, wherein the first hinge component includes a female cavity component.

12. The apparatus of claim 11, wherein the second hinge component includes a male extension component.

13. A method, comprising:
inserting a male extension component of a first hinge component into a female cavity component of a second hinge component;
inserting a screw into a first screw hole of the first hinge component and a second screw hole of the second hinge component; and
rotating the screw in a first direction to couple the first hinge component and the second hinge component.

14. The method of claim 13, including rotating the screw in a second direction to uncouple the first hinge component and the second hinge component.

15. The method of claim 14, including removing the screw from the first hinge component and the second hinge component.

16. The method of claim 15, including detaching the male extension component of the first hinge component from the female cavity component of the second hinge component to uncouple a first eyewear component and a second eyewear component.

17. The method of claim 16, wherein the first eyewear component is a frame.

18. The method of claim 16, wherein the second eyewear component is a temple arm.
